(19) United States
(12) Patent Application Publication
(10) Pub. No.: US 2015/0032258 A1
(43) Pub. Date: Jan. 29, 2015

(54) APPARATUS AND METHODS FOR CONTROLLING OF ROBOTIC DEVICES

(71) Applicant: BRAIN CORPORATION, San Diego, CA (US)

(72) Inventors: Jean-Baptiste Passot, La Jolla, CA (US); Patryk Laurent, San Diego, CA (US); Eugene M. Izhikevich, San Diego, CA (US)

(73) Assignee: BRAIN CORPORATION, San Diego, CA (US)

(21) Appl. No.: 13/953,595

(22) Filed: Jul. 29, 2013

(51) Int. Cl. B25J 9/16

(52) U.S. Cl. CPC B25J 9/163
USPC 700/250

(57) ABSTRACT

A robot may be trained based on cooperation between an operator and a trainer. During training, the operator may control the robot using a plurality of control instructions. The trainer may observe movements of the robot and generate a plurality of control commands, such as gestures, sound and/or light wave modulation. Control instructions may be combined with the trainer commands via a learning process in order to develop an association between the two. During operation, the learning process may generate one or more control instructions based on one or more gesture by the trainer. One or both the trainer or the operator may comprise a human, and/or computerized entity.

### CROSS-REFERENCE TO RELATED APPLICATIONS

This application is related to co-pending and co-owned U.S. patent application Ser. No. 13/918,338 entitled “ROBOTIC TRAINING APPARATUS AND METHODS”, filed Jun. 14, 2013; U.S. patent application Ser. No. 13/918,298 entitled “HIERARCHICAL ROBOTIC CONTROLLER APPARATUS AND METHODS”, filed Jun. 14, 2013; U.S. patent application Ser. No. 13/918,620 entitled “PREDICTIVE ROBOTIC CONTROLLER APPARATUS AND METHODS”, filed Jun. 14, 2013; U.S. patent application Ser. No. 13/907,734 entitled “ADAPTIVE ROBOTIC INTERFACE APPARATUS AND METHODS”, filed May 31, 2013; U.S. patent application Ser. No. 13/842,530 entitled “ADAPTIVE PREDICTOR APPARATUS AND METHODS”, filed Mar. 15, 2013; U.S. patent application Ser. No. 13/842,562 entitled “ADAPTIVE PREDICTOR APPARATUS AND METHODS FOR ROBOTIC CONTROL”, filed Mar. 15, 2013; U.S. patent application Ser. No. 13/842,616 entitled “ROBOTIC APPARATUS AND METHODS FOR DEVELOPING A HIERARCHY OF MOTOR PRIMITIVES”, filed Mar. 15, 2013; U.S. patent application Ser. No. 13/842,647 entitled “MULTICHANNEL ROBOTIC CONTROLLER APPARATUS AND METHODS”, filed Mar. 15, 2013; and U.S. patent application Ser. No. 13/842,583 entitled “APPARATUS AND METHODS FOR TRAINING OF ROBOTIC DEVICES”, filed Mar. 15, 2013; each of the foregoing being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technological Field

The present disclosure relates to adaptive control and training of robotic devices.

2. Background

Robotic devices are used in a variety of applications, such as manufacturing, medical, safety, military, exploration, and/or other applications. Some existing robotic devices (e.g., manufacturing assembly and/or packaging) may be programmed in order to perform desired functionality. Some robotic devices (e.g., surgical robots) may be remotely controlled by humans, while some robots (e.g., iRobot Roomba®) may learn to operate via exploration.

Robotic devices may comprise hardware components that may enable the robot to perform actions in one-, two-, and/or three-dimensional space. Some robotic devices may comprise one or more components configured to operate in more than one spatial dimension (e.g., a turret and/or a crane arm configured to rotate around vertical and/or horizontal axes). Some robotic devices may be configured to operate in more than one spatial dimension orientation so that their components may change their operational axis (e.g., with respect to vertical direction) based on the orientation of the robot platform. Robotic devices may be characterized by complex dynamics characterizing their forward and inverse transform functions between control input and executed action (behavior). Training of robots may be employed in order to characterize the transfer function and/or to enable the robot to perform a particular task.

### SUMMARY

One aspect of the disclosure relates to a non-transitory computer readable medium having instructions embodied thereon. The instructions may be executable by one or more processors to: cause a robot to execute a plurality of actions based on one or more directives; receive information related to a plurality of commands provided by a trainer based on individual ones of the plurality of actions; and associate individual ones of the plurality of actions with individual ones of the plurality of commands using a learning process.

In some implementations, the robot may comprise at least one actuator configured to be operated by a motor instruction. Individual ones of the one or more directives may comprise the motor instruction provided based on input by an operator. The association may be configured to produce a mapping between given command and a corresponding instruction.

In some implementations, the instructions may be further executable by one or more processors to cause provision of a motor instruction based on another command provided by the trainer.

Another aspect of the disclosure relates to a processor-implemented method of operating a robotic apparatus. The method may be performed by one or more processors configured to execute computer program modules. The method may comprise: during at least one training interval: providing, using one or more processors, a plurality of control instructions configured to cause the robotic apparatus to execute a plurality of actions; and receiving, using one or more processors, a plurality of commands configured based on the plurality of actions being executed; and during an operation interval occurring subsequent to the at least one training interval: providing, using one or more processors, a control instruction of the plurality of control instructions, the control instruction being configured to cause the robotic apparatus to execute an action of the plurality of actions, the control instruction provision being configured based on a mapping between individual ones of the plurality of actions and individual ones of the plurality of commands.

In some implementations, the plurality of control instructions may be provided based on directives by a first entity in operable communication with the robotic apparatus. The plurality of commands may be provided by a second entity disposed remotely from the robotic apparatus. The control instruction may be provided based on a provision by the second entity of a respective command of the plurality of commands.

In some implementations, the method may further comprise causing a transition from the at least one training interval to the operational interval based on an event provided by the second entity. The first entity may comprise a computerized apparatus configured to communicate the plurality of control instructions to the robotic apparatus. The robotic apparatus may comprise an interface configured to detect the plurality of commands.

In some implementations, the first entity may comprise a human. Individual ones of the plurality of commands may comprise one or more of a human gesture, a voice signal, an audible signal, or an eye movement.

In some implementations, the robotic apparatus may comprise at least one actuator characterized by an axis of motion. Individual ones of the plurality of actions may be configured to displace the actuator with respect to the axis of motion. The interface may comprise one or more of a visual sensing device, an audio sensor, or a touch sensor. The event may be configured based on timer expiration.

In some implementations, the mapping may be effectuated by an adaptive controller of the robotic apparatus operable by a spiking neuron network characterized by a learning parameter configured in accordance with a learning process. The at least one training interval may comprise a plurality of training intervals. For a given training interval of the plurality of training intervals, the learning parameter may be determined based on a similarity measure between individual ones of the plurality of actions and respective individual ones of the plurality of commands.

In some implementations, the learning parameter may be determined based on multiple values of the similarity measure determined for multiple ones of the plurality of training intervals. Individual ones of the multiple values of the similarity measure may be determined based on a given one of the plurality of actions and a respective one of the plurality of commands occurring during individual ones of the multiple ones of the plurality of training intervals.

In some implementations, the similarity measure may be determined based on one or more of a cross-correlation determination, a clustering determination, a distance-based determination, a probability determination, or a classification determination.

In some implementations, at least one training interval may comprise a plurality of training intervals. The mapping may be effectuated by an adaptive controller of the robotic apparatus operable in accordance with a learning process. The learning process may be configured based on one or more tables including one or more of a look up table, a hash-table, or a data base table. A given table may be configured to store a relationship between given one of the plurality of actions and a respective one of the plurality of commands occurring during individual ones of the multiple ones of the plurality of training intervals.

In some implementations, individual ones of the plurality of actions may be characterized by a state parameter of the robotic apparatus. The plurality of actions may be configured in accordance with a trajectory in a state space. The trajectory may be characterized by variations in the state parameter between successive actions of the plurality of actions.

In some implementations, the trajectory may be configured based on a random selection of the state for individual ones of the plurality of actions.

In some implementations, individual ones of the plurality of actions may be characterized by a pair of state parameters of the robotic apparatus in a state space characterized by at least two dimensions. The plurality of actions may be configured in accordance with a trajectory in a state space. The trajectory may be characterized by variations in the state parameter between successive actions of the plurality of actions.

In some implementations, the at least two dimensions may be selected from the group consisting of coordinates in a two-dimensional plane, motor torque, motor rotational angle, motor velocity, and motor acceleration.

In some implementations, the trajectory may comprise a plurality of set-points disposed within the state-space. Individual ones of the set-points may be characterized by a state value selected prior to onset of the at least one training interval.

In some implementations, the trajectory may comprise a periodically varying trajectory characterized by multiple pairs of state values. The state values within individual pairs may be disposed opposite one another relative to a reference.

In some implementations, the method may further comprise: during the at least one training interval: providing at least one predicted control instruction based on a given command of the plurality of commands, the given command corresponding to a given control instruction of the plurality of control instructions; determining a performance measure based on a similarity measure between the predicted control instruction and the given control instruction; and causing a transition from the at least one training interval to the operational interval based on the performance measure breaching a transition threshold.

Yet another aspect of the disclosure relates to a computerized system. The system may comprise a robotic device, a control interface, a sensing interface, and an adaptive controller. The robotic device may comprise at least one motor actuator. The control interface may be configured to provide a plurality of instructions for the actuator based on an signal from an operator. The sensing interface may be configured to detect one or more training commands configured based on a plurality of actions executed by the robotic device based on the plurality of instructions. The adaptive controller may be configured to: provide a mapping between the one or more training commands and the plurality of instructions; and provide a control command based on a command by the trainer. The control command may be configured to cause the actuator to execute a respective action of the plurality of actions.

These and other features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

FIG. 1 is a block diagram illustrating a robotic apparatus, according to one or more implementations.

FIG. 2 is a graphical illustration depicting a robotic arm comprising joints configured to enable arm motion with two degrees of freedom, according to one or more implementations.

FIG. 3A is a graphical illustration depicting target trajectories for use during training of a robotic device characterized by two degrees of motion freedom, according to one or more implementations.

FIG. 3B is a graphical illustration depicting exemplary trajectories for use during training of a robotic device characterized by one degree of motion freedom, according to one or more implementations.

FIG. 4 is a graphical illustration of robotic device operation timeline, in accordance with one or more implementations.

FIG. 5 is a plot illustrating performance of an adaptive robotic apparatus of, e.g., FIG. 2 and/or FIGS. 6A-7B during training and operation, in accordance with one or more implementations.

FIG. 6A is a graphical illustration of robotic device training configuration, in accordance with one or more implementations.

FIG. 6B is a graphical illustration of robotic device training configuration comprising context acquisition external to the robotic device, in accordance with one or more implementations.

FIG. 7A is a block diagram illustrating a computerized system configured to implement training of a robotic device, according to one or more implementations.

FIG. 7B is a block diagram illustrating a controller apparatus comprising an adaptable predictor block for use with, e.g., system of FIG. 6A, according to one or more implementations.

FIG. 8 is a logical flow diagram illustrating a method of training an adapting controller of a robot based on operator instructions and trainer commands, in accordance with one or more implementations.

FIG. 9 is a logical flow diagram illustrating a method of operating a robotic device based on trainer commands and previously determined mapping between trainer commands and control instructions, in accordance with one or more implementations.

FIG. 10 is a logical flow diagram illustrating a method of determining an association between operator instructions and trainer commands by an adaptive remoter controller apparatus, in accordance with one or more implementations.

All Figures disclosed herein are © Copyright 2013 Brain Corporation. All rights reserved.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to a single implementation, but other implementations are possible by way of interchange of or combination with some or all of the described or illustrated elements. Wherever convenient, the same reference numbers will be used throughout the drawings to refer to same or like parts.

Where certain elements of these implementations can be partially or fully implemented using known components, only those portions of such known components that are necessary for an understanding of the present technology will be described, and detailed descriptions of other portions of such known components will be omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “bus” is meant generally to denote all types of interconnection or communication architecture that is used to access the synaptic and neuron memory. The “bus” may be optical, wireless, infrared, and/or another type of communication medium. The exact topology of the bus could be for example standard “bus”, hierarchical bus, network-on-chip, address-event-representation (AER) connection, and/or other type of communication topology used for accessing, e.g., different memories in pulse-based system.

As used herein, the terms “computer”, “computing device”, and “computerized device” may include one or more of personal computers (PCs) and/or minicomputers (e.g., desktop, laptop, and/or other PCs), mainframe computers, workstations, servers, personal digital assistants (PDAs), handheld computers, embedded computers, programmable logic devices, personal communicators, tablet computers, portable navigation aids, J2ME equipped devices, cellular telephones, smart phones, personal integrated communication and/or entertainment devices, and/or any other device capable of executing a set of instructions and processing an incoming data signal.

As used herein, the term “computer program” or “software” may include any sequence of human and/or machine cognizable steps which perform a function. Such program may be rendered in a programming language and/or environment including one or more of C/C++, C#, Fortran, COBOL, MATLAB™, PASCAL, Python, assembly language, markup languages (e.g., HTML, SGML, XML, VoXML), object-oriented environments (e.g., Common Object Request Broker Architecture (CORBA)), Java™ (e.g., J2ME, Java Beans), Binary Runtime Environment (e.g., BREW), and/or other programming languages and/or environments.

As used herein, the terms “connection”, “link”, “transmission channel”, “delay line”, “wireless” may include a causal link between any two or more entities (whether physical or logical/virtual), which may enable information exchange between the entities.

As used herein, the term “memory” may include an integrated circuit and/or other storage device adapted for storing digital data. By way of non-limiting example, memory may include one or more of ROM, PROM, EEPROM, DRAM, Mobile DRAM, SDRAM, DDR/2 SDRAM, EDO/FPMS, RLDRAM, SRAM, “flash” memory (e.g., NAND/NOR), memristor memory, PSRAM, and/or other types of memory.

As used herein, the terms “integrated circuit”, “chip”, and “IC” are meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), application-specific integrated circuits (ASICs), and/or other types of integrated circuits.

As used herein, the terms “microprocessor” and “digital processor” are meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “network interface” refers to any signal, data, and/or software interface with a component, network, and/or process. By way of non-limiting example, a network interface may include one or more of FireWire (e.g., FW400, FW800, etc.), USB (e.g., USB2), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), Wi-Fi (802.11), WiMAX (802.16), PAN (e.g., 802.15), cellular (e.g., 3G, LTE/LTE-A/TD-LTE, GSM, etc.), IrDA families, and/or other network interfaces.

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

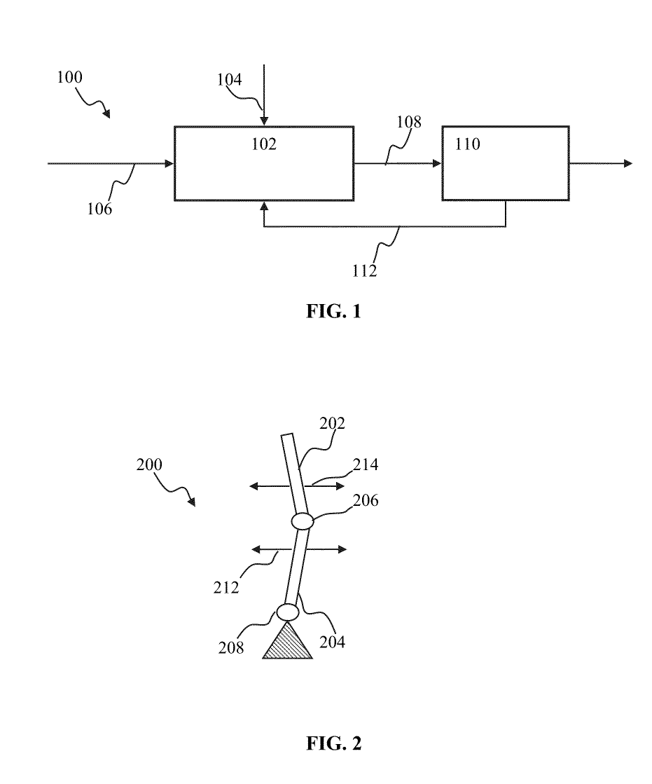

FIG. 1 illustrates one implementation of an adaptive robotic apparatus for use with the robot training methodology described herein. The apparatus 100 of FIG. 1 may comprise an adaptive controller 102 and a plant (e.g., robotic platform 110). The controller 102 may be configured to generate control output 108 for the plant 110. The output 108 may comprise one or more motor commands (e.g., pan camera to the right), sensor acquisition parameters (e.g., use high resolution camera mode), commands to the wheels, arms, and/or other actuators on the robot, and/or other parameters. The output 108 may be configured by the controller 102 based on one or more sensory inputs 106. The input 106 may comprise data used for solving a particular control task. In one or more implementations, such as those involving a robotic arm or autonomous robot, the signal 106 may comprise a stream of raw sensor data and/or preprocessed data. Raw sensor data may include data conveying information associated with one or more of proximity, inertial, terrain imaging, and/or other information. Preprocessed data may include data conveying information associated with one or more of velocity, information extracted from accelerometers, distance to obstacle, positions, and/or other information. In some implementations, such as that involving object recognition, the signal 106 may comprise an array of pixel values in the input image, or preprocessed data. Pixel data may include data conveying information associated with one or more of RGB, CMYK, HSV, HSL, grayscale, and/or other information. Preprocessed data may include data conveying information associated with one or more of levels of activations of Gabor filters for face recognition, contours, and/or other information. In one or more implementations, the input signal 106 may comprise a target motion trajectory. The motion trajectory may be used to predict a future state of the robot on the basis of a current state and the target state. In one or more implementations, the signals in FIG. 1 may be encoded as spikes, as described in detail in U.S. patent application Ser. No. 13/842,530 entitled “ADAPTIVE PREDICTOR APPARATUS AND METHODS”, filed Mar. 15, 2013, incorporated supra.

The controller 102 may be operable in accordance with a learning process (e.g., reinforcement learning and/or supervised learning). In one or more implementations, the controller 102 may optimize performance (e.g., performance of the system 100 of FIG. 1) by minimizing average value of a performance function as described in detail in co-owned U.S. patent application Ser. No. 13/487,533, entitled “STOCHASTIC SPIKING NETWORK LEARNING APPARATUS AND METHODS”, incorporated herein by reference in its entirety.

Learning process of adaptive controller (e.g., 102 of FIG. 1) may be implemented using a variety of methodologies. In some implementations, the controller 102 may comprise an artificial neuron network e.g., the spiking neuron network described in U.S. patent application Ser. No. 13/487,533, entitled “STOCHASTIC SPIKING NETWORK LEARNING APPARATUS AND METHODS”, filed Jun. 4, 2012, incorporated supra, configured to control, for example, a robotic rover.

Individual spiking neurons may be characterized by internal state. The internal state may, for example, comprise a membrane voltage of the neuron, conductance of the membrane, and/or other parameters. The neuron process may be characterized by one or more learning parameters, which may comprise input connection efficacy, output connection efficacy, training input connection efficacy, response generating (firing) threshold, resting potential of the neuron, and/or other parameters. In one or more implementations, some learning parameters may comprise probabilities of signal transmission between the units (e.g., neurons) of the network.

In some implementations, the training input (e.g., 104 in FIG. 1) may be differentiated from sensory inputs (e.g., inputs 106) as follows. During learning, data (e.g., spike events) arriving to neurons of the network via input 106 may cause changes in the neuron state (e.g., increase neuron membrane potential and/or other parameters). Changes in the neuron state may cause the neuron to generate a response (e.g., output a spike). Teaching data arriving to neurons of the network may cause (i) changes in the neuron dynamic model (e.g., modify parameters a, b, c, d of Izhikevich neuron model, described for example in co-owned U.S. patent application Ser. No. 13/623,842, entitled “SPIKING NEURON NETWORK ADAPTIVE CONTROL APPARATUS AND METHODS”, filed Sep. 20, 2012, incorporated herein by reference in its entirety); and/or (ii) modification of connection efficacy, based, for example, on timing of input spikes, teacher spikes, and/or output spikes. In some implementations, teaching data may trigger neuron output in order to facilitate learning. In some implementations, teaching signal may be communicated to other components of the control system.

During operation (e.g., subsequent to learning), data (e.g., spike events) arriving to neurons of the network may cause changes in the neuron state (e.g., increase neuron membrane potential and/or other parameters). Changes in the neuron state may cause the neuron to generate a response (e.g., output a spike). Teaching data may be absent during operation, while input data are required for the neuron to generate output.

In one or more implementations, such as object recognition and/or obstacle avoidance, the input 106 may comprise a stream of pixel values associated with one or more digital images. In one or more implementations (e.g., video, radar, sonography, x-ray, magnetic resonance imaging, and/or other types of sensing), the input may comprise electromagnetic waves (e.g., visible light, IR, UV, and/or other types of electromagnetic waves) entering an imaging sensor array. In some implementations, the imaging sensor array may comprise one or more of RGCs, a charge coupled device (CCD), an active-pixel sensor (APS), and/or other sensors. The input signal may comprise a sequence of images and/or image frames. The sequence of images and/or image frame may be received from a CCD camera via a receiver apparatus and/or downloaded from a file. The image may comprise a two-dimensional matrix of RGB values refreshed at a 25 Hz frame rate. It will be appreciated by those skilled in the arts that the above image parameters are merely exemplary, and many other image representations (e.g., bitmap, CMYK, HSV, HSL, grayscale, and/or other representations) and/or frame rates are equally useful with the present technology. Pixels and/or groups of pixels associated with objects and/or features in the input frames may be encoded using, for example, latency encoding described in U.S. patent application Ser. No. 12/869,583, filed Aug. 26, 2010 and entitled “INVARIANT PULSE LATENCY CODING SYSTEMS AND METHODS”; U.S. Pat. No. 8,315,305, issued Nov. 20, 2012, entitled “SYSTEMS AND METHODS FOR INVARIANT PULSE LATENCY CODING”; U.S. patent application Ser. No. 13/152,084, filed Jun. 2, 2011, entitled “APPARATUS AND METHODS FOR PULSE-CODE INVARIANT OBJECT RECOGNITION”; and/or latency encoding comprising a temporal winner take all mechanism described U.S. patent application Ser. No. 13/757,607, filed Feb. 1, 2013 and entitled “TEMPORAL WINNER TAKES ALL SPIKING NEURON NETWORK SENSORY PROCESSING APPARATUS AND METHODS”, each of the foregoing being incorporated herein by reference in its entirety.

In one or more implementations, object recognition and/or classification may be implemented using spiking neuron classifier comprising conditionally independent subsets as described in co-owned U.S. patent application Ser. No. 13/756,372 filed Jan. 31, 2013, and entitled “SPIKING NEURON CLASSIFIER APPARATUS AND METHODS” and/or co-owned U.S. patent application Ser. No. 13/756,382 filed Jan. 31, 2013, and entitled “REDUCED LATENCY SPIKING NEURON CLASSIFIER APPARATUS AND METHODS”, each of the foregoing being incorporated herein by reference in its entirety.

In one or more implementations, encoding may comprise adaptive adjustment of neuron parameters, such neuron excitability described in U.S. patent application Ser. No. 13/623,820 entitled “APPARATUS AND METHODS FOR ENCODING OF SENSORY DATA USING ARTIFICIAL SPIKING NEURONS”, filed Sep. 20, 2012, the foregoing being incorporated herein by reference in its entirety.

In some implementations, analog inputs may be converted into spikes using, for example, kernel expansion techniques described in co pending U.S. patent application Ser. No. 13/623,842 filed Sep. 20, 2012, and entitled “SPIKING NEURON NETWORK ADAPTIVE CONTROL APPARATUS AND METHODS”, the foregoing being incorporated herein by reference in its entirety. In one or more implementations, analog and/or spiking inputs may be processed by mixed signal spiking neurons, such as U.S. patent application Ser. No. 13/313,826 entitled “APPARATUS AND METHODS FOR IMPLEMENTING LEARNING FOR ANALOG AND SPIKING SIGNALS IN ARTIFICIAL NEURAL NETWORKS”, filed Dec. 7, 2011, and/or co-pending U.S. patent application Ser. No. 13/761,090 entitled “APPARATUS AND METHODS FOR IMPLEMENTING LEARNING FOR ANALOG AND SPIKING SIGNALS IN ARTIFICIAL NEURAL NETWORKS”, filed Feb. 6, 2013, each of the foregoing being incorporated herein by reference in its entirety.

The rules may be configured to implement synaptic plasticity in the network. In some implementations, the plastic rules may comprise one or more spike-timing dependent plasticity, such as rule comprising feedback described in co-owned and co-pending U.S. patent application Ser. No. 13/465,903 entitled “SENSORY INPUT PROCESSING APPARATUS IN A SPIKING NEURAL NETWORK”, filed May 7, 2012; rules configured to modify of feed forward plasticity due to activity of neighboring neurons, described in co-owned U.S. patent application Ser. No. 13/488,106, entitled “SPIKING NEURON NETWORK APPARATUS AND METHODS”, filed Jun. 4, 2012; conditional plasticity rules described in U.S. patent application Ser. No. 13/541,531, entitled “CONDITIONAL PLASTICITY SPIKING NEURON NETWORK APPARATUS AND METHODS”, filed Jul. 3, 2012; plasticity configured to stabilize neuron response rate as described in U.S. patent application Ser. No. 13/691,554, entitled “RATE STABILIZATION THROUGH PLASTICITY IN SPIKING NEURON NETWORK”, filed Nov. 30, 2012; activity-based plasticity rules described in co-owned U.S. patent application Ser. No. 13/660,967, entitled “APPARATUS AND METHODS FOR ACTIVITY-BASED PLASTICITY IN A SPIKING NEURON NETWORK”, filed Oct. 25, 2012, U.S. patent application Ser. No. 13/660,945, entitled “MODULATED PLASTICITY APPARATUS AND METHODS FOR SPIKING NEURON NETWORKS”, filed Oct. 25, 2012; and U.S. patent application Ser. No. 13/774,934, entitled “APPARATUS AND METHODS FOR RATE-MODULATED PLASTICITY IN A SPIKING NEURON NETWORK”, filed Feb. 22, 2013; multi-modal rules described in U.S. patent application Ser. No. 13/763,005, entitled “SPIKING NETWORK APPARATUS AND METHOD WITH BIMODAL SPIKE-TIMING DEPENDENT PLASTICITY”, filed Feb. 8, 2013, each of the foregoing being incorporated herein by reference in its entirety.

In one or more implementations, neuron operation may be configured based on one or more inhibitory connections providing input configured to delay and/or depress response generation by the neuron, as described in U.S. patent application Ser. No. 13/660,923, entitled “ADAPTIVE PLASTICITY APPARATUS AND METHODS FOR SPIKING NEURON NETWORK”, filed Oct. 25, 2012, the foregoing being incorporated herein by reference in its entirety

Connection efficacy updated may be effectuated using a variety of applicable methodologies such as, for example, event based updates described in detail in co-owned U.S. patent application Ser. No. 13/239, filed Sep. 21, 2011, entitled “APPARATUS AND METHODS FOR SYNAPTIC UPDATE IN A PULSE-CODED NETWORK”; 201220, U.S. patent application Ser. No. 13/588,774, entitled “APPARATUS AND METHODS FOR IMPLEMENTING EVENT-BASED UPDATES IN SPIKING NEURON NETWORK”, filed Aug. 17, 2012; and U.S. patent application Ser. No. 13/560,891 entitled “APPARATUS AND METHODS FOR EFFICIENT UPDATES IN SPIKING NEURON NETWORKS”, each of the foregoing being incorporated herein by reference in its entirety.

A neuron process may comprise one or more learning rules configured to adjust neuron state and/or generate neuron output in accordance with neuron inputs.

In some implementations, the one or more learning rules may comprise state dependent learning rules described, for example, in U.S. patent application Ser. No. 13/560,902, entitled “APPARATUS AND METHODS FOR STATE-DEPENDENT LEARNING IN SPIKING NEURON NETWORKS”, filed Jul. 27, 2012 and/or pending U.S. patent application Ser. No. 13/722,769 filed Dec. 20, 2012, and entitled “APPARATUS AND METHODS FOR STATE-DEPENDENT LEARNING IN SPIKING NEURON NETWORKS”, each of the foregoing being incorporated herein by reference in its entirety.

In one or more implementations, the one or more leaning rules may be configured to comprise one or more reinforcement learning, unsupervised learning, and/or supervised learning as described in co-owned and co-pending U.S. patent application Ser. No. 13/487,499 entitled “STOCHASTIC APPARATUS AND METHODS FOR IMPLEMENTING GENERALIZED LEARNING RULES, incorporated supra.

In one or more implementations, the one or more leaning rules may be configured in accordance with focused exploration rules such as described, for example, in U.S. patent application Ser. No. 13/489,280 entitled “APPARATUS AND METHODS FOR REINFORCEMENT LEARNING IN ARTIFICIAL NEURAL NETWORKS”, filed Jun. 5, 2012, the foregoing being incorporated herein by reference in its entirety.

Adaptive controller (e.g., the controller apparatus 102 of FIG. 1) may comprise an adaptable predictor block configured to, inter alia, predict control signal (e.g., 108) based on the sensory input (e.g., 106 in FIG. 1) and teaching input (e.g., 104 in FIG. 1) as described in, for example, U.S. patent application Ser. No. 13/842,530 entitled “ADAPTIVE PREDICTOR APPARATUS AND METHODS”, filed March 15, 2013, incorporated supra.

FIG. 2 is illustrates a robotic arm comprising joints configured to enable arm motion with two degrees of freedom, according to one or more implementations. The arm 200 may comprise two portions 202, 204 coupled to motorized joints 206, 208. The motors 206, 208 may be controlled by an operator in order to move the portions 202, 208 in directions indicated by arrows 214, 212. In some implementations, the operator may utilize an interface capable of controlling single motorized joint at a time. The interface may allow the operator to signal only the joint angle, the target change in angle, and/or a torque to be applied to the portion. A toggle and/or multiple position switch on the interface may allow the operator to select the joint to be controlled. The arm may have constraints imposed on its range of motion, for example, the angle between portions 202 and 204 must always be acute angles less than 180°.

In one or more implementations, the operator may utilize an adaptive remote controller apparatus configured in accordance with operational configuration of the arm 200, e.g., as described in U.S. patent application Ser. No. 13/907,734 entitled “ADAPTIVE ROBOTIC INTERFACE APPARATUS AND METHODS”, filed May 31 2013, incorporated supra. In some implementations, the operator may utilize a hierarchical remote controller apparatus configured, for example, to operate motors of both joints using single control element (e.g., a knob) as described., for example, in U.S. patent application Ser. No. 13/918,298 entitled “HIERARCHICAL ROBOTIC CONTROLLER APPARATUS AND METHODS”, filed Jun. 14, 2013, incorporated supra. In some implementations, the operator may interface to the robot via an operative link configured to communicate one or more control commands. The operative link may comprise a serial connection (wired and/or wireless), according to some implementations. The one or more control commands may be stored in a command file (e.g., a script file). The individual commands may be configured in accordance with a communication protocol of a given motor (e.g., command ‘A10000’ may be used to move the motor in an absolute position 10000). The file may be communicated to the robot using any of the applicable interfaces (e.g., a serial link, a microcontroller, flash memory card inserted into the robot, and/or other interfaces).

Training of the robotic arm 200 may be configured as follows, in one or more implementations. The operator may control the arm to perform an action, e.g., position one or both arm portions 206, 208 at a particular orientation/position. Operator instructions (e.g., turning of a knob) may be configured to cause a specific motor instruction (e.g., command A10000) to be communicated to the robotic device.

Another entity (also referred to as the trainer), may observe the behavior of the arm 200 responsive to the operator instructions. In one or more implementations, the trainer may comprise a human and/or a computerized agent. The observation may be based on use of a video camera and/or human eyes, e.g., as described in detail with respect to FIGS. 5A-5B, below.

The trainer may be configured to initiate multiple commands associated with the motion of the arm 200. In one or more implementations, the commands may comprise gestures (e.g., a gesture performed by a hand, arm, leg, foot, head, and/or other parts of human body), eye movement, voice commands, audible commands (e.g., claps), other command forms (e.g., motion of a mechanized robotic arm, and/or changes in light brightness, color, beam footprint size, and/or polarization of a computer-controlled light source), and/or other commands.

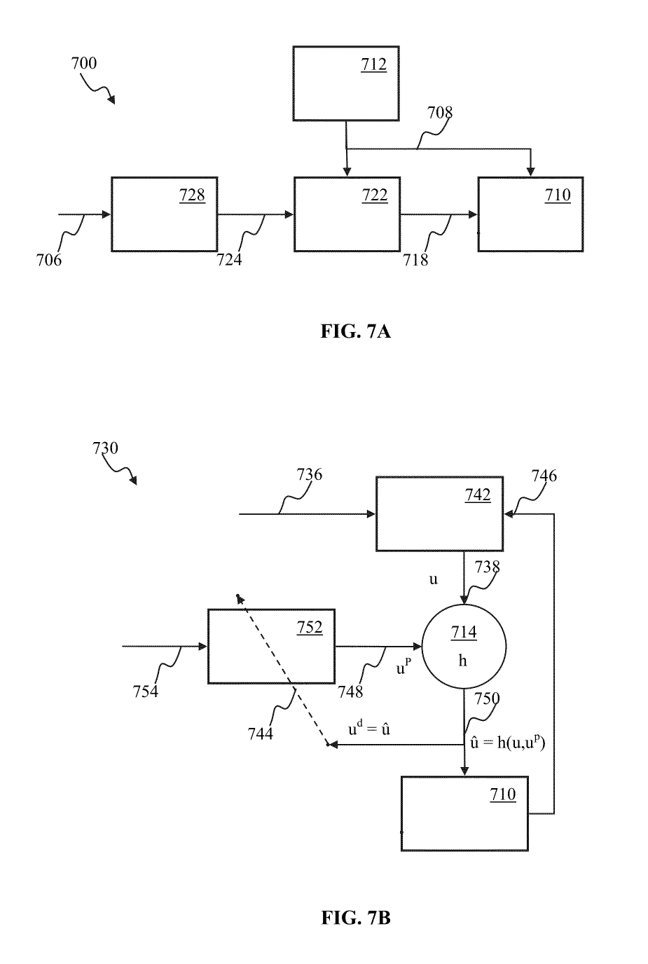

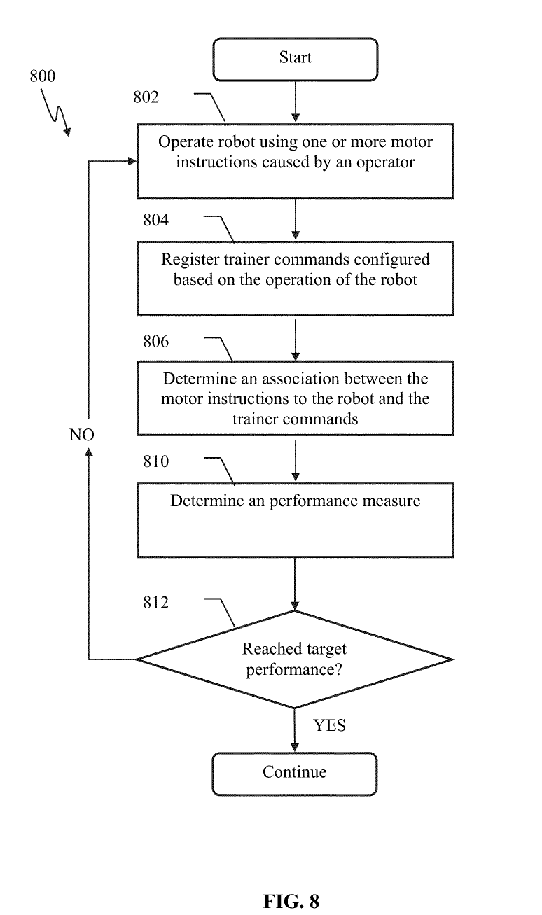

Trainer commands may be registered by a corresponding sensing apparatus configured in accordance with the nature of commands. In one or more implementations, the registering/sensing apparatus may comprise a video recording device, touch sensing device, a sound recording device, and/or other apparatus or device. The sensing apparatus may be coupled to an adaptive controller. The adaptive controller may be configured to determine an association between the registered trainer commands and the motor commands provided to the robot based on the operator instructions. In one or more implementations, the association may be based on operating a neuron network in accordance with a learning process, e.g., as described in detail with respect to FIGS. 7A-7B. In some implementations, the association may be based on a correlation measure between the trainer commands and the motor commands. In some implementations, the association may be determined using a look-up table (LUT) configured to store relative occurrence of a given motor command and a respective trainer command.

Operation of a robotic device may be characterized by a state space. By way of non-limiting illustration, position the arm 200 may be characterized by positions of individual arm portions 202, 204 and/or their angles of orientation. The state space of the arm may comprise the first portion 202 orientation ×1 that may be selected between ±90° and ×2 the second portion 204 orientation between that may be selected between ±90°. Arm operation based on the operator instructions may be characterized by a trajectory within the state space (×1, ×2) configured in accordance with the operator instructions.

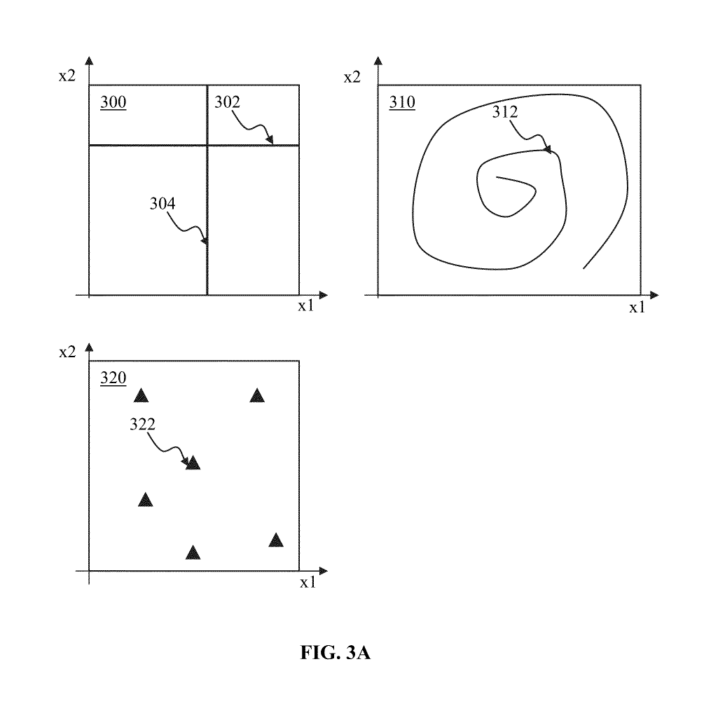

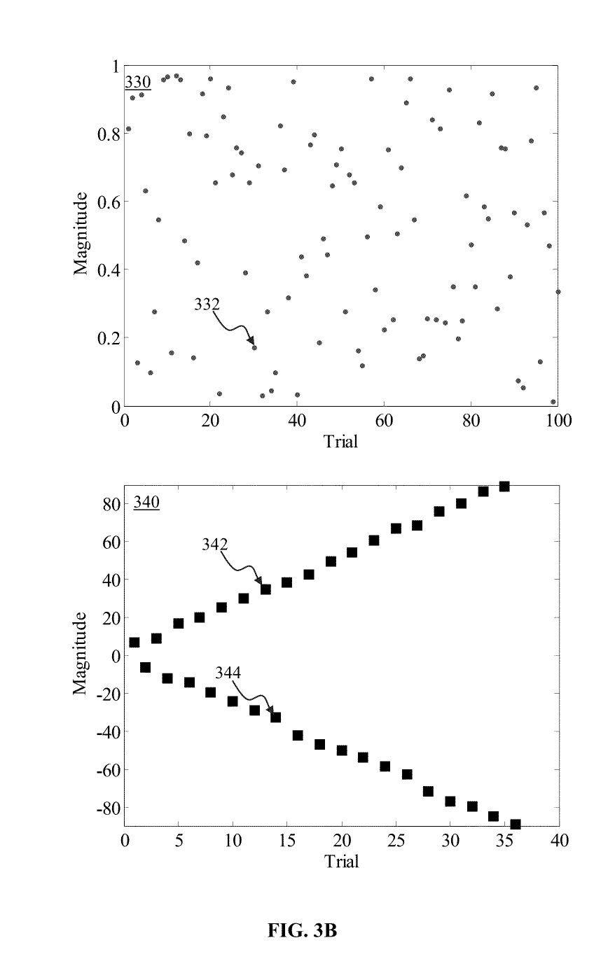

FIGS. 3A-3B present exemplary state-space (×1, ×2) trajectories useful with the training methodology of the disclosure. Panel 300 in FIG. 3A depicts trajectories 302, 304 describing arm 200 orientation. In some implementations (e.g., the panel 300), operator instructions may be configured to decouple variations in one state parameter (e.g., arm portion 202 orientation ×1) from variations in the other state parameter (e.g., arm portion 204 orientation ×2), as shown by lines 304, 302, respectively.

In some implementations (e.g., illustrated by panel 310), operator instructions may be configured to obtain extended coverage (compared to the trajectories in panel 300) within the parameter space, as shown by curve 312. In some implementations, operator may employ multiple set points/waypoints, e.g., waypoints 322 in the panel 320 of FIG. 3A. The use of set points (e.g., as shown in panel 320) may aid a human trainer in following training trajectory of the robot.

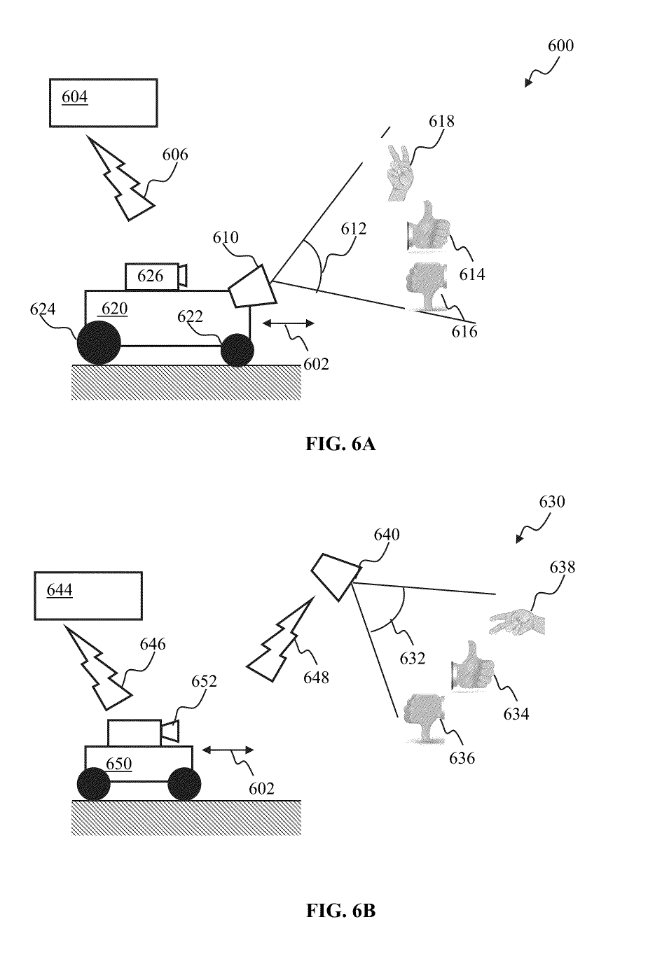

In one or more implementations, operator instructions may be configured to obtain comprehensive coverage of the parameter space, as illustrated by trajectory shown in panel 330 in FIG. 3B. The trajectory shown in panel 330 depicts use of randomly generated state space locations (e.g., 332) that may be used by the operator during training In some implementations of random training trajectories, the operator may comprise a computerized agent interfaced to the robot via, e.g., a serial link configured to transmit motor commands. The trainer may comprise a computerized agent configured to detect random behavior of the robot and respond to these in a timely manner. In some implementations, the trainer and the operator may be realized by a single computerized system, e.g., as described with respect to FIG. 6A below.

In one or more implementations, operator instructions may be configured to follow a trajectory comprising a plurality of alternating state states, as illustrated by trajectory shown in panel 330 in FIG. 3B. The trajectory shown in panel 340 depicts use of alternating state space locations (e.g., a positive deviation angle 342 and a negative deviation angle 344) that may be used by the operator during training The trajectory of panel 340 may be utilized during training with a human trainer who may be capable of predicting the robot movement due to oscillating (periodic) nature of the trajectory.

The training trajectories shown in FIG. 3B may be utilized for training individual degrees of freedom by, e.g., varying the orientation angle of the joint 206 independent from the orientation angle of the joint 208.

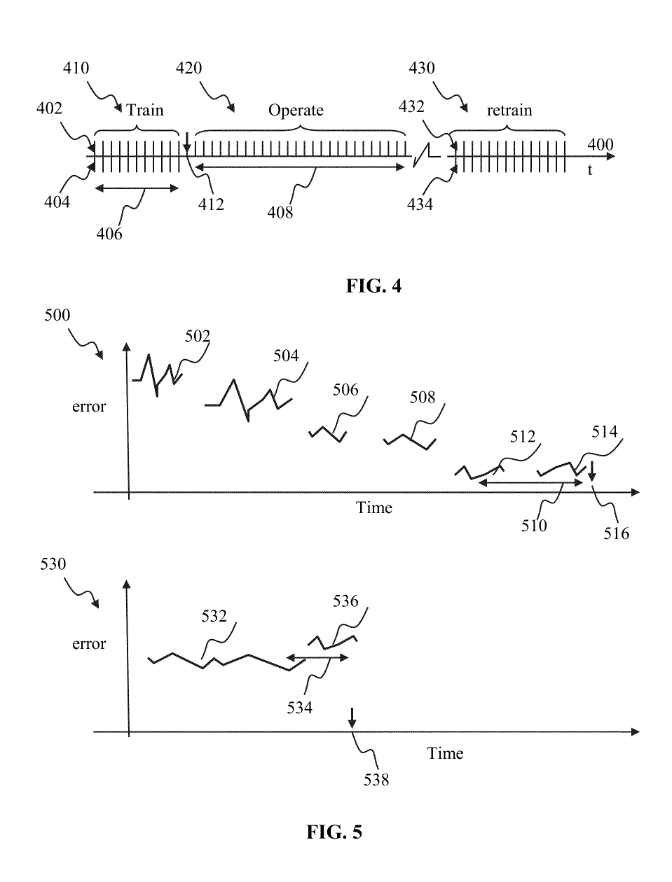

FIG. 4 presents a timeline of robotic device operation configured using training methodology described herein, in accordance with one or more implementations. Operation process illustrated in FIG. 4 may comprise one or more sessions 410, 420, 430, having the same (not shown) or different (e.g., 406, 408) duration. During session 410, a robot may be trained based on collaboration between operator instructions and trainer commands, shown by bars 404, 402, respectively, in FIG. 4. The operator instructions may be configured to generate one or more motor commands (e.g., turn right wheel by 60°) to the robotic device under training An association between the motor commands and the trainer commands may be established during the training session 410. Responsive to an event, depicted by arrow 412, the training session 410 may switch over to operational session 420. The operational session 420 may be configured based on trainer commands and one or motor commands generated by an adaptive controller based on the previously established association between the motor commands and the trainer commands. In one or more implementations, the event 412 may be configured based on timer expiration, an input from, e.g., the trainer, the operator, and/or another entity. In some implementations, the event 412 may be configured based on a performance measure attaining a target level, e.g., an error breaching a minimum error threshold.

Subsequent to the session 430, a robot may be re-trained during another training session, e.g., 430 in FIG. 4. During session 410, a robot may be trained based on collaboration between operator instructions and trainer commands, shown by bars 434, 432, respectively, in FIG. 4. The transition from the operational session 420 to the re-training session 430 may be configured based on a timer expiration, an input from e.g., the trainer, the operator, and/or another entity, a change in operational context (e.g., change of robot and/or of robot's environment configuration), and/or other event. In one or more implementations, the change of robot configuration may be due to a failure of robot's hardware (e.g., a flat wheel), reduced battery energy, and/or other parameter. In one or more implementations, the change of environment configuration may be due to change in environmental conditions (e.g., onset/disappearance of wind, rain, and/or snow), appearance of new objects (e.g., rocks on the road), other environmental changes (e.g., clouds reducing available solar energy), and/or other changes.

FIG. 5 illustrates performance of an adaptive robotic apparatus of, e.g., FIG. 2 and/or FIGS. 6A-7B during training and operation, in accordance with one or more implementations.

Panel 500 in FIG. 5 presents data performance data associated with one or more training intervals (e.g., the interval 410 in FIG. 4). In one or more implementations, e.g. as shown by curves 502, 504, 506, 506, 508, 512, 514 in FIG. 5, training performance may be determined based on an error (discrepancy) between a target trajectory and actual trajectory of the robot. The discrepancy measure may comprise one or more of maximum deviation, maximum absolute deviation, average absolute deviation, mean absolute deviation, mean difference, root mean square error, cumulative deviation, and/or other measures. In one or more implementations, training performance may be determined based on a match (e.g., a correlation) between the target trajectory and the actual trajectory of the robot. The performance evaluation may be effectuated by a computerized apparatus configured to receive the operator input (e.g., 708 in FIG. 7A) and data related to the actual robot trajectory, e.g., by analyzing a video stream of robot movements). Performance evaluation may be characterized by a time interval (e.g., 510 in FIG. 5). In one or more implementations, the time interval may correspond to a correlation time window (e.g., maximum lag), a running mean window, a mean error determination window and/or other durations. The performance measure may be utilized for implementing training In some implementations, performance breaching a threshold (e.g., error below a given level) may trigger a ‘stop training’ event generation (e.g., the event 412 in FIG. 4). In one or more implementations, an event 516 may be generated based on the sustained level of performance within a given interval, as shown by error associated with curves 512, 514 in FIG. 5. In some implementations, the training performance evaluation illustrated in panel 500 of FIG. 5 may be effectuated by an adaptive controller of a robot (e.g., the robotic device 620 described in detail with respect to FIG. 6A below.

Panel 530 in FIG. 5 illustrates performance of a robotic device during operation, e.g., the interval 420 of FIG. 4. In one or more implementations, the performance shown by curves 532, 534 may be determined using one or more of similarity and/or discrepancy measures, e.g., as described above with respect to panel 530. Performance curves shown in panel 530 may be obtained based on one or more of a comparison between trainer commands, control instructions generated based on the mapping learned during training, robots actual trajectory, and/or other information. In some implementations, the performance may be determined based on a comparison (e.g., a correlation) between the control instructions generated based on the mapping and the control instructions provided by the operator during training. During operation of the robotic device, an indication 538 may be generated upon detecting a change in level of performance. The change detection may comprise detection of an instantaneous change in the performance e(t), e.g., e(t+1)−e(t)>δe; and/or detection of a change in the performance within a time interval, e.g., 534 in FIG. 5.

FIG. 6A illustrates a computerized system configured to implement training of a robotic device, in accordance with one or more implementations. The system 600 may comprise an operator 604 in in operable communication with the robotic device 620 via a remote link 606. In one or more implementations, the link 606 may comprise one or more of a wired link (e.g., Ethernet, T1, USB, FireWire, Thunderbolt, another serial link, and/or other wired link), a wireless link (e.g., Wi-Fi, Bluetooth, infrared, radio, cellular, millimeter wave, satellite, and/or other wireless link), and/or other link.

The robotic device 620 may comprise one or more controllable elements (e.g., wheels 622, 624, turret 626, and/or other controllable elements). The link 606 may be utilized to transmit instructions from the operator 604 to the robot 620. The instructions may comprise one or more motor primitives (e.g., rotate the wheel 622, elevate the turret 626, and/or other motor primitives) and/or task indicators (e.g., move along direction 602, approach, fetch, and/or other indicators).

The robotic device 620 may comprise a sensing apparatus 610 configured to register one or more training commands provided by a trainer. In one or more implementations, the sensing apparatus 610 may comprise a video capturing device characterized by a field of view 612. The trainer may be prompted to initiate multiple commands associated with the motion of the robotic device 620. In one or more implementations, e.g., illustrated in FIG. 6A, the trainer commands may comprise gestures (e.g., hand gestures forward 614, backward 616, stop 618, and/or other gestures). In some implementations, (not shown) the trainer commands may comprise one or more of movement of a body part (e.g., an arm, a leg, a foot, a head, and/or other part of human body), eye movement, voice commands, audible commands (e.g., claps), motion of a mechanized robotic arm, changes in light of a computer-controlled light source (e.g., brightness, color, beam footprint size, and/or polarization), and/or other commands. In one or more implementations, the trainer input that may appear within the field of view 612 of the sensing apparatus 610 may be referred to as sensory context.

The sensing apparatus may 610 be coupled to an adaptive controller (not shown). The adaptive controller may be configured to determine an association between the sensed trainer commands (e.g., forward gesture 614) and the respective motor command(s) that may be provided to the robot based on the operator 604 instructions (e.g., via the link 606).

FIG. 6B illustrates a system for training of robotic device wherein sensory context acquisition is configured external to the robotic device 650, in accordance with one or more implementations. The system 630 may comprise an operator 644 in in operable communication with the robotic device 650 via a remote link 646.

The robotic device 650 may comprise one or more controllable elements (e.g., Wheels, an antenna, and/or other controllable elements). The link 646 may be utilized to transmit instructions from the operator 644 to the robot 650. The instructions may comprise one or more of a motor primitive (e.g., rotate the wheel, rotate the turret 652, and/or other motor primitives), a task indicator (e.g., move along direction 602, approach, fetch, and/or other indicators), and/or other instructions.

The system 630 may comprise a sensing apparatus 640 configured to register one or more training commands provided by a trainer. In one or more implementations, the sensing apparatus 640 may comprise a touch sensitive device characterized by a sensing extent 632. The trainer may be prompted to initiate multiple commands associated with the motion of the robotic device 650. In one or more implementations, e.g., illustrated in FIG. 6B, the trainer commands may comprise touch gestures (e.g., the gesture forward 634, backward 636, stop 638, and/or other gestures).

The sensing apparatus may 640 be operably coupled to an adaptive controller via an operative link. The controller may be configured to determine an association between the sensed trainer commands (e.g., forward gesture 634) and the respective motor command(s) that may be provided to the robot based on the operator 604 instructions (e.g., via the link 646). In some implementations, the adaptive controller may be embodied in the robotic device 650 and configured to receive the sensory context via, e.g., link 648. The link 606 may comprise one or more of a wired link (e.g., Ethernet, DOCSIS modem, T1, DSL, USB, FireWire, Thunderbolt, anther serial link, and/or another wired link), a wireless link (e.g. Wi-Fi, Bluetooth, infrared, radio, cellular, millimeter wave, satellite), and/or another link. In some implementations, the adaptive controller may be embodied with the sensing apparatus 640. The adaptive controller may be configured to receive the motor commands associated with the operator instructions via, e.g., the link 648. In some implementations, the adaptive controller may be embodied in a computerized apparatus disposed remote from the sensing apparatus 640 and the robotic device 650. The adaptive controller, in some implementations, may be configured to receive the motor commands associated with the operator instructions via, e.g., the link 648 and the sensory context (trainer commands) from the sensing apparatus 650. The remote controller apparatus may be configured to provide the determined association parameters between the sensed trainer commands (e.g., forward gesture 634) and the respective motor command(s).

In one or more implementations, the association parameters may comprise a transformer function configured to provide a motor command responsive to a particular context (e.g., the forward gesture 634). In some implementations, the association may be determined using a look-up table configured to store relative occurrence of a given motor command and a respective trainer command.

FIG. 7A is a block diagram illustrating a computerized system configured to implement training of a robotic device, according to one or more implementations. The system 700 may comprise one or more of an adaptive controller 722, interfaced to a trainer 728, a control entity 712, a robotic platform 710, and/or other components. The control entity 712 may comprise the operator 604 of FIG. 6A, in one or more implementations. The control entity may be configured to operate the robotic platform 710 by providing control signal 708. The signal 708 may convey one or more of a motor command (e.g., pan camera to the right); a sensor acquisition parameter (e.g., use high resolution camera mode); a command to the wheels, arms, and/or other actuators on the robot; and/or other information. The trainer entity 728 may comprise computerized and/or human trainer described above with respect to FIGS. 6A-6B. Trainer may be configured to receive sensory input 706 by, e.g., observing motion of the robot. Based on the observations of the robot and/or environment, the trainer may provide teaching commands 724 to the adaptive controller 722. In one or more implementations, the trainer commands may comprise gestures, audio, and/or other commands, such as described, for example, above with respect to FIGS. 6A-6B.

During training (e.g., the interval 410 described with respect to FIG. 4 above), the adaptive controller 722 may be operable in accordance with a learning process. The learning process may include one or more of a supervised learning process, a reinforcement learning process, and/or other learning processes. The learning process may be configured to determine an association between control input 708 of the operator and trainer commands 724. In one or more implementations, the association parameters may comprise a transform function configured to provide a motor command responsive to a particular context (e.g., the forward gesture 634 in FIG. 6B). In some implementations, the association may be determined using a LUT configured to store relative co-occurrence of a given motor command and respective sensory input data that includes a respective trainer command.

During operation (e.g., the interval 420 described with respect to FIG. 4 above and characterized by absence of input from the control entity 712), the adaptive controller 722 may be configured to produce control output 718 in accordance with the trainer input 724 and learned association. This may be accomplished by deactivating the motor instructions 708 via a switch, or reconfiguring the combiner entity 710 or 714 to ignore the contribution of control inputs 708 or 738, respectively.

FIG. 7B illustrates an adaptive controller apparatus 730 comprising an adaptable predictor block for use with, e.g., system of FIG. 7A, according to one or more implementations. The adaptive controller apparatus 730 of FIG. 7B may comprise one or more of a control entity 742, an adaptive predictor 752, a combiner 714, and/or other components.

The control entity 742 may comprise the operator 604 of FIG. 6A and/or entity 712 of FIG. 7A, in one or more implementations. The control entity may be configured to operate the robotic platform 750 by providing control signal 738. The signal 738 may convey one or more of a motor command (e.g., pan camera to the right and/or other motor command); a sensor acquisition parameter (e.g., use high resolution camera mode and/or other sensor acquisition parameter); a command to the wheels, arms, and/or other actuators on the robot; and/or other information. The control entity 742 may be configured to generate control signal 738 based on one or more of (i) sensory input (denoted 736 in FIG. 7B), (ii) robotic platform feedback 746, and/or other information. In some implementations, robotic platform feedback may comprise proprioceptive signals. A proprioceptive signal may convey one or more of readings from servo motors, joint position, torque, and/or other proprioceptive information. In some implementations, the sensory input 736 may correspond to the controller sensory input 106, described with respect to FIG. 1, supra. In one or more implementations, the control entity may comprise a human trainer, communicating with the robotic controller via a remote controller and/or joystick. In one or more implementations, the control entity may comprise a computerized agent such as a multifunction adaptive controller operable using reinforcement and/or unsupervised learning and capable of training other robotic devices for one and/or multiple tasks.

The predictor 752 may be configured to receive an input 754 from a training entity (e.g., 728 of FIG. 7A). The input 754 may correspond to video and/or electrical signals associated with trainer gestures, audio and/or other commands provided via, e.g., the link 648 of FIG. 6B, described above. Trainer may be configured to receive a sensory input (by, e.g., observing motion of the robot). Based on the observations of the robot and/or environment, the trainer may provide teaching commands 754 to the predictor 752. In one or more implementations, the trainer commands may comprise gestures, audio, and or other commands, such as described, for example, above with respect to FIGS. 6A-6B.

During training (e.g., the interval 410 described with respect to FIG. 4 above), the predictor 752 may be operable in accordance with a learning process. The learning process may include one or more of a supervised learning process, a reinforcement learning process, and/or other learning process. The learning process may be configured to determine an association between control input 738 of the operator and trainer commands 754. In one or more implementations, the association parameters may comprise a transformer function configured to provide a motor command responsive to a particular context (e.g., the ‘move forward’ gesture 634 in FIG. 6B). In some implementations, the association may be determined using a LUT configured to store relative occurrence of a given motor command and a respective trainer command.

The learning process of the adaptive predictor 752 may comprise one or more of a supervised learning process, a reinforcement learning process, and/or other learning process. The control entity 742, the predictor 752, and/or the combiner 714 may cooperate to produce a control signal 750 for the robotic platform 710. In one or more implementations, the control signal 750 may convey one or more of a motor command (e.g., pan camera to the right, turn right wheel forward, and/or other motor commands), a sensor acquisition parameter (e.g., use high resolution camera mode and/or other sensor acquisition parameter), and/or other information.

The adaptive predictor 752 may be configured to generate predicted control signal u^{P} 718 based on one or more of (i) the sensory input 736, (ii) the robotic platform feedback 716_{—}1, and/or other information. The predictor 752 may be configured to adapt its internal parameters, e.g., according to a supervised learning rule and/or other machine learning rules.

Predictor implementations, comprising robotic platform feedback, may be employed in applications such as, for example, wherein (i) the control action may comprise a sequence of purposefully timed commands (e.g., associated with approaching a stationary target, such as a cup, by a robotic manipulator arm, and/or other commands); (ii) the robotic platform may be characterized by a robotic platform state time parameter (e.g., arm inertia, motor response time, and/other parameters) that may be greater than the rate of action updates; and/or other applications. Parameters of a subsequent command within the sequence may depend on the robotic platform state (e.g., the exact location and/or position of the arm joints) that may become available to the predictor via the robotic platform feedback.

The sensory input and/or the robotic platform feedback may collectively be referred to as sensory context. The context may be utilized by the predictor 752 in order to produce the predicted output 748. By way of a non-limiting illustration of obstacle avoidance by an autonomous rover, an image of an obstacle (e.g., wall representation in the sensory input 736) may be combined with rover motion (e.g., speed and/or direction) to generate Context_A. Responsive to the Context_A being encountered, the control output 750 may comprise one or more commands configured to avoid a collision between the rover and the obstacle. Based on one or more prior encounters of the Context_A—avoidance control output, the predictor may build an association between these events as described in detail below.

The combiner 714 may implement a transfer function h( ) configured to combine the control signal 738 and the predicted control signal 748. In some implementations, the combiner 714 operation may be expressed as described in detail in U.S. patent application Ser. No. 13/842,530 entitled “ADAPTIVE PREDICTOR APPARATUS AND METHODS”, filed Mar. 15, 2013, as follows:

û=h(u,u^{P}). (Eqn. 1)

Various implementations of the transfer function of Eqn. 1 may be utilized. In some implementations, the transfer function may comprise one or more of an addition operation, a union, a logical ‘AND’ operation, and/or other operations. In one or more implementations, the transfer function may comprise a convolution operation. In spiking network implementations of the combiner function, the convolution operation may be supplemented by use of a finite support kernel such as Gaussian, rectangular, exponential, and/or other finite support kernel. Such a kernel may implement a low pass filtering operation of input spike train(s). In some implementations, the transfer function may be characterized by a commutative property configured such that:

û=h(u,u^{P})=h(u^{P},u). (Eqn. 2)

In one or more implementations, the transfer function of the combiner 714 may be configured as follows:

h(0,u^{P})=u^{P}. (Eqn. 3)

In some implementations, the transfer function h may be configured as:

h(u,0)=u. (Eqn. 4)

The transfer function h may be configured as a combination of implementations of Eqn. 3-Eqn. 4 as:

h(0,u^{P})=u^{P}, and h(u,0)=u. (Eqn. 5)

In one exemplary implementation, the transfer function satisfying Eqn. 5 may be expressed as:

h(u,u^{P})=(1−u)×(1−u^{P})−1. (Eqn. 6)

In some implementations, the combiner transfer function configured according to Eqn. 3-Eqn. 6, thereby implementing an additive feedback. In other words, output of the predictor (e.g., 748) may be additively combined with the control signal (738) and the combined signal 750 may be used as the teaching input (744) for the predictor. In some implementations, the combined signal 750 may be utilized as an input (context) signal (not shown) into the predictor 752.

In some implementations, the combiner transfer function may be characterized by a delay expressed as:

û(tᵢ₊₁)=h(u(tᵢ),u^{P}(tᵢ)). (Eqn. 7)

In Eqn. 7, û(tᵢ₊₁) denotes combined output (e.g., 750 in FIG. 7B) at time t+Δt. As used herein, symbol t_{N} may be used to refer to a time instance associated with individual controller update events (e.g., as expressed by Eqn. 7), for example t₁ denoting time of the first control output, e.g., a simulation time step and/or a sensory input frame step. In some implementations of training autonomous robotic devices (e.g., rovers, bi-pedaling robots, wheeled vehicles, aerial drones, robotic limbs, and/or other robotic devices), the update periodicity At may be configured to be between 1 ms and 1000 ms.

It will be appreciated by those skilled in the arts that various other implementations of the transfer function of the combiner 714 (e.g., a Heaviside step function, a sigmoidal function, a hyperbolic tangent, a Gauss error function, a logistic function, a stochastic operation, and/or other function or operation) may be applicable.

Operation of the predictor 752 learning process may be aided by a teaching signal 704. As shown in FIG. 7B, the teaching signal 744 may comprise the output 750 of the combiner:

u^{d}=Û. (Eqn. 8)

In some implementations wherein the combiner transfer function may be characterized by a delay τ (e.g., Eqn. 7), the teaching signal at time tᵢ may be configured based on values of u, u^{P} at a prior time tᵢ₋₁, for example as:

u^{d}(tᵢ)=h(u(tᵢ₋₁), u^{P}(tᵢ₋₁)). (Eqn. 9)

The training signal u^{d} at time tᵢ may be utilized by the predictor in order to determine the predicted output u^{P} at a subsequent time tᵢ₊₁, corresponding to the context (e.g., the sensory input x) at time tᵢ:

u^{P}(tᵢ₊₁)=F[χᵢ, W(u^{d}(tᵢ))]. (Eqn. 10)

In Eqn. 10, the function W may refer to a learning process implemented by the predictor.

In one or more implementations, the sensory input 736, the control signal 738, the predicted output 748, the combined output 750 and/or robotic platform feedback 746 may comprise one or more of a spiking signal, an analog signal, and/or another signal. Analog-to-spiking conversion and/or spiking-to-analog signal conversion may be effectuated using mixed signal spiking neuron networks, such as, for example, described in U.S. patent application Ser. No. 13/313,826 entitled “APPARATUS AND METHODS FOR IMPLEMENTING LEARNING FOR ANALOG AND SPIKING SIGNALS IN ARTIFICIAL NEURAL NETWORKS”, filed Dec. 7, 2011, and/or co-pending U.S. patent application Ser. No. 13/761,090 entitled “APPARATUS AND METHODS FOR IMPLEMENTING LEARNING FOR ANALOG AND SPIKING SIGNALS IN ARTIFICIAL NEURAL NETWORKS”, filed Feb. 6, 2013, incorporated supra.

Output 750 of the combiner e.g., 714 in FIG. 7B, may be gated. In some implementations, the gating may be implemented by the control entity 742, as described in U.S. patent application Ser. No. 13/842,562 entitled “ADAPTIVE PREDICTOR APPARATUS AND METHODS FOR ROBOTIC CONTROL”, filed Mar. 15, 2013, incorporated, supra.

The gating information may be used by the combiner network to switch the transfer function operation.

In some implementations, prior to learning, the gating information may be used to configure the combiner to generate the combiner output 750 comprised solely of the control signal portion 748, e.g., in accordance with Eqn. 4. During training, prediction performance may be evaluated as follows:

ε(tᵢ)=|u^{P}(tᵢ₋₁)−u^{d}(tᵢ)|. (Eqn. 11)

In other words, prediction error may be based on how well a prior predictor output matches the current (e.g., target) input. In one or more implementations, predictor error may comprise a root-mean-square deviation (RMSD), coefficient of variation, and/or other parameters.

As the training progresses, predictor performance (e.g., error) may be monitored. In some implementations, the predictor performance monitoring may comprise comparing predictor performance to a threshold (e.g., minimum error), determining performance trend (e.g., over a sliding time window) and or other operations. Upon determining that predictor performance has reached a target level of performance (e.g. , the error of Eqn. 11 drops below a threshold) training mode may be switch to operation mode, e.g., as described with respect to FIG. 4, supra.

In some implementation, the gating information may be utilized to modulate control output 750 composition. For example, the gating information may be used to gradually increase weighting of the predicted signal 748 portion in the combined output 750. In one or more implementations, the gating information may act as a switch from training mode, to operational mode and/or back to training.

FIGS. 8-10 illustrate methods of training and operation of robotic apparatus, in accordance with one or more implementations. The operations of methods 800, 900, 1000 presented below are intended to be illustrative. In some implementations, methods 800, 900, 1000 may be accomplished with one or more additional operations not described, and/or without one or more of the operations discussed. Additionally, the order in which the operations of methods 800, 900, 1000 are illustrated in FIGS. 8-10 described below is not intended to be limiting.

In some implementations, methods 800, 900, 1000 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of methods 800, 900, 1000 in response to instructions stored electronically on an electronic storage medium. The one or more processing devices may include one or more devices configured through hardware, firmware, and/or software to be specifically designed for execution of one or more of the operations of methods 800, 900, 1000. Operations of methods 800, 900, 1000 may be utilized with a robotic apparatus, such as illustrated in FIGS. 6A-6B.

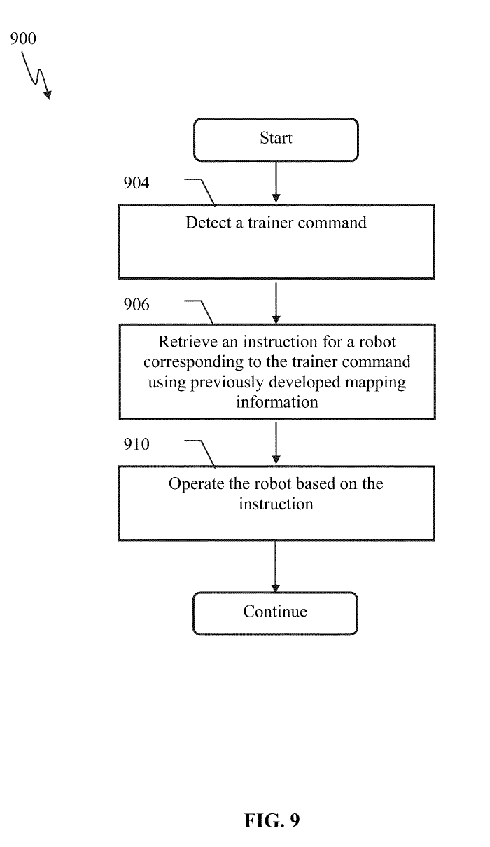

FIG. 9 illustrates a method of operating a robotic device based on trainer commands and previously determined mapping between the trainer commands and control instructions, in accordance with one or more implementations.

At operation 904, a trainer command may be detected. In some implementations, the command of a human trainer may comprise movement of a body part (e.g., an arm, a leg, a foot, a head, and/or other part of human body), eye movement, voice commands, audible commands (e.g., claps), and/or other command. In some implementations of a computerized trainer, the trainer command may comprise movement of a mechanized robotic arm, changes in light of a computer-controlled light source (e.g., brightness, color, beam footprint size, and/or polarization), and/or other information. In one or more implementations, the trainer command may be registered by a corresponding sensing apparatus configured in accordance with the nature of commands. In one or more implementations, the registering/sensing apparatus may comprise a video recording device, touch sensing device, a sound recording device, and/or other apparatus or device. The sensing apparatus may be coupled to an adaptive controller, configured to determine an association between the registered trainer commands and the motor commands provided to the robot based on the operator instructions.

At operation 906, an instruction corresponding to the trainer command may be retrieved. The instruction may comprise one or more motor commands, e.g., configured to operate one or more controllable elements of the robot platform (e.g., turn a wheel). The instruction retrieval may be based on mapping (association) information that may have been previously developed during training, e.g., using methodology of method 800 described above. with respect to FIG. 8. In one or more implementations, the mapping information may comprise a table and/or a transfer function configured to provide one or more control instructions (e.g., motor commands) corresponding to the trainer input.

At operation 910, the robotic platform may be operated based on the control instruction provided at operation 908. In some implementations, the operation 910 may comprise one or more of following a trajectory, rotation of a wheel, movement of an arm, performing of a task (e.g., fetching an object), and/or other operations.

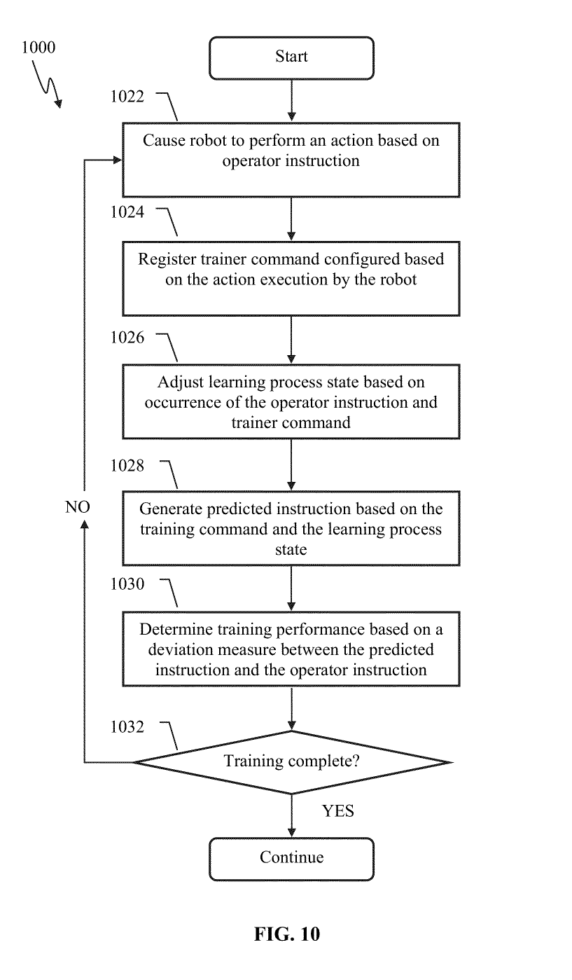

FIG. 10 illustrates a method of developing an association (mapping) between control instructions provided to a robot by an operator and trainer commands.

At operation 1022, a robot may be operated. The operation may comprise causing the robot to perform an action based on operator instruction. In some implementations, the robot may be remotely controlled by an operator using a remote controller apparatus, e.g., as described in U.S. patent application Ser. No. 13/907,734 entitled “ADAPTIVE ROBOTIC INTERFACE APPARATUS AND METHODS”, filed May 31, 2013. The operator instructions may be configured to cause provision of one or more motor primitives (e.g., rotate a wheel, elevate an arm, and/or other task primitives) and/or task indicators (e.g., move along a direction, approach, fetch, and/or other indicators) to a robotic controller. In some implementations, the motor commands may be provided by a pre-trained an optimal controller.

At operation 1024, a trainer command may be detected. In some implementations, the trainer commands may comprise one or more of a movement of a body part (e.g., an arm, a leg, a foot, a head, and/or other part of human body), eye movement, voice commands, audible commands (e.g., claps), motion of a mechanized robotic arm, changes in light of a computer-controlled light source (e.g., brightness, color, beam footprint size, and/or polarization), and/or other commands. In one or more implementations, the trainer commands may be registered by a corresponding sensing apparatus configured in accordance with the nature of commands. In one or more implementations, the registering/sensing apparatus may comprise a video recording device, touch sensing device, a sound recording device, and or other. The sensing apparatus may be coupled to an adaptive controller. The adaptive controller may be configured to determine an association between the registered trainer commands and the motor commands provided to the robot based on the operator instructions. In one or more implementations, the trainer commands and/or operator instructions may be provided by a computerized apparatus (e.g., an optimal controller).

At operation 1026, an association between the motor instructions to the robot and the trainer commands may be determined. In one or more implementations, the association may be based on operating a neuron network in accordance with a learning process. The learning process may be effectuated by adjusting efficacy of one or more connections between neurons. In some implementations, the association may be determined using a look-up table configured to store relative co-occurrence of a given motor instruction and respective sensory input data that includes a trainer command. In one or more implementations, the motor instructions from the control entity 712 and trainer commands may be configured based on one or more state space trajectories (e.g., random, oscillating, linear, a spiral-like, shown in FIGS. 3A-3B, and/or other trajectories). Those skilled in the art will appreciate that regular periodic, rather than a random motion, may yield faster convergence of the neuron network or similar learning mechanism. At operation 1028, predicted instruction may be generated. The predicted instruction may be based on the training command of the trainer and the learning process state. In some implementations, the predicted instruction may be determined using an entry that may correspond to the trainer command in a LUT.

At operation 1030, training performance may be determined. The training performance determination may be based on a deviation measure between the predicted instruction and the operator instruction associated with operation of the robot. The deviation measure may comprise one or more of maximum deviation, maximum absolute deviation, average absolute deviation, mean absolute deviation, mean difference, root mean square error, cumulative deviation, and/or other measures. In one or more implementations, training performance may be determined based on a match (e.g., a correlation) between the predicted instruction and the operator instruction associated with operation of the robot.

At operation 1032, performance assessment may be made. Responsive to determination that present performance reached target, an event may be generated. In some implementations, the event may comprise ‘stop training’ event, e.g., the event 516 described with respect to FIG. 5. In one or more implementations, performance assessment may be based on present performance value breaching a threshold value (e.g., an error falling below maximum allowed error and/or a correlation exceeding minimum affordable correlation).

Responsive to a determination that present performance has not reached the target, the method 1000 may proceed to operation 1022.

One or more of the methodologies comprising collaborative training of robotic devices described herein may facilitate training and/or operation of robotic devices. In some implementations, a complex robot comprising multiple degrees of freedom of motion (e.g., a humanoid robot, a manipulator with three or more joints, and/or other) may be trained using the methodology described herein. Such robotic devices may be characterized by a transfer function that may be difficult to model and/or obtain analytically. In some implementations, collaborative training descried herein may be employed in order to establish the transfer function in an empirical way as follows: a computerized operator may be configured to control individual joints of a multi joint robot (in accordance with, e.g., a command script and/or a computer program); a trainer may utilize gestures and/or other commands responsive to the motion of the robot; and a learning system may be employed to establish mapping between control instructions and trainer movements.

In some implementations, methodology of the present disclosure may enable collaborative training of one or more robots by other robots, e.g. by executing a command script by a trainee robot and observing motion of a trainer robot. In some implementations, such training may be implemented remotely wherein the trainer and the trainee robot may be disposed remote from one another. By way of an illustration, an exploration robot (e.g., working underwater, in space, and/or in a radioactive environment, may be trained by a remote trainer located in safer environment.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. This description is in no way meant to be limiting, but rather should be taken as illustrative of the general principles of the technology. The scope of the disclosure should be determined with reference to the claims.

What is claimed is:

1. A non-transitory computer readable medium having instructions embodied thereon, the instructions being executable by one or more processors to:
cause a robot to execute a plurality of actions based on one or more directives;
receive information related to a plurality of commands provided by a trainer based on individual ones of the plurality of actions; and
associate individual ones of the plurality of actions with individual ones of the plurality of commands using a learning process.

2. The non-transitory computer readable medium of claim 1, wherein:
the robot comprises at least one actuator configured to be operated by a motor instruction;
individual ones of the one or more directives comprise the motor instruction provided based on input by an operator; and
the association is configured to produce a mapping between given command and a corresponding instruction.

3. The non-transitory computer readable medium of claim 1, wherein the instructions are further executable by one or more processors to cause provision of a motor instruction based on another command provided by the trainer.

4. A processor-implemented method of operating a robotic apparatus, the method being performed by one or more processors configured to execute computer program modules, the method comprising:
during at least one training interval:
providing, using one or more processors, a plurality of control instructions configured to cause the robotic apparatus to execute a plurality of actions; and
receiving, using one or more processors, a plurality of commands configured based on the plurality of actions being executed; and
during an operation interval occurring subsequent to the at least one training interval:
providing, using one or more processors, a control instruction of the plurality of control instructions, the control instruction being configured to cause the robotic apparatus to execute an action of the plurality of actions, the control instruction provision being configured based on a mapping between individual ones of the plurality of actions and individual ones of the plurality of commands.

5. The method of claim 4, wherein:
the plurality of control instructions is provided based on directives by a first entity in operable communication with the robotic apparatus;
the plurality of commands is provided by a second entity disposed remotely from the robotic apparatus; and
the control instruction is provided based on a provision by the second entity of a respective command of the plurality of commands.

6. The method of claim 5, further comprising:
causing a transition from the at least one training interval to the operational interval based on an event provided by the second entity;
wherein:
the first entity comprises a computerized apparatus configured to communicate the plurality of control instructions to the robotic apparatus; and
the robotic apparatus comprises an interface configured to detect the plurality of commands.

7. The method of claim 6, wherein:
the first entity comprises a human; and
individual ones of the plurality of commands comprise one or more of a human gesture, a voice signal, an audible signal, or an eye movement.

8. The method of claim 6, wherein:
the robotic apparatus comprises at least one actuator characterized by an axis of motion;
individual ones of the plurality of actions are configured to displace the actuator with respect to the axis of motion;
the interface comprises one or more of a visual sensing device, an audio sensor, or a touch sensor; and
the event is configured based on a timer expiration.

9. The method of claim 4, wherein:
the mapping is effectuated by an adaptive controller of the robotic apparatus operable by a spiking neuron network characterized by a learning parameter configured in accordance with a learning process;
the at least one training interval comprises a plurality of training intervals; and
for a given training interval of the plurality of training intervals, the learning parameter is determined based on a similarity measure between individual ones of the plurality of actions and respective individual ones of the plurality of commands.

10. The method of claim 9, wherein the learning parameter is determined based on multiple values of the similarity measure determined for multiple ones of the plurality of training intervals, individual ones of the multiple values of the similarity measure being determined based on a given one of the plurality of actions and a respective one of the plurality of commands occurring during individual ones of the multiple ones of the plurality of training intervals.

11. The method of claim 9, wherein the similarity measure is determined based on one or more of a cross-correlation determination, a clustering determination, a distance-based determination, a probability determination, or a classification determination.

12. The method of claim 4, wherein:
at least one training interval comprises a plurality of training intervals;
the mapping is effectuated by an adaptive controller of the robotic apparatus operable in accordance with a learning process; and
the learning process is configured based on one or more tables including one or more of a look up table, a hash-table, or a data base table, a given table being configured to store a relationship between given one of the plurality of actions and a respective one of the plurality of commands occurring during individual ones of the multiple ones of the plurality of training intervals.

13. The method of claim 4, wherein:
individual ones of the plurality of actions are characterized by a state parameter of the robotic apparatus; and
the plurality of actions is configured in accordance with a trajectory in a state space, the trajectory being characterized by variations in the state parameter between successive actions of the plurality of actions.

14. The method of claim 13, wherein the trajectory is configured based on a random selection of the state for individual ones of the plurality of actions.

15. The method of claim 4, wherein:
individual ones of the plurality of actions are characterized by a pair of state parameters of the robotic apparatus in a state space characterized by at least two dimensions; and
the plurality of actions is configured in accordance with a trajectory in a state space, the trajectory being characterized by variations in the state parameter between successive actions of the plurality of actions.

16. The method of claim 15, wherein the at least two dimensions are selected from the group consisting of coordinates in a two-dimensional plane, motor torque, motor rotational angle, motor velocity, and motor acceleration.

17. The method of claim 15, wherein the trajectory comprises a plurality of set-points disposed within the state-space, individual ones of the set-points being characterized by a state value selected prior to onset of the at least one training interval.

18. The method of claim 15, wherein the trajectory comprises a periodically varying trajectory characterized by multiple pairs of state values, the state values within individual pairs being disposed opposite one another relative to a reference.

19. The method of claim 4, further comprising:
during the at least one training interval:
providing at least one predicted control instruction based on a given command of the plurality of commands, the given command corresponding to a given control instruction of the plurality of control instructions;
determining a performance measure based on a similarity measure between the predicted control instruction and the given control instruction; and
causing a transition from the at least one training interval to the operational interval based on the performance measure breaching a transition threshold.

20. A computerized system comprising:
a robotic device comprising at least one motor actuator;
a control interface configured to provide a plurality of instructions for the actuator based on an signal from an operator;
a sensing interface configured to detect one or more training commands configured based on a plurality of actions executed by the robotic device based on the plurality of instructions; and
an adaptive controller configured to:
provide a mapping between the one or more training commands and the plurality of instructions; and
provide a control command based on a command by the trainer;
wherein the control command is configured to cause the actuator to execute a respective action of the plurality of actions.
